(19) United States
(12) Patent Application Publication
(10) Pub. No.: US 2026/0249362 A1
(43) Pub. Date: Aug. 27, 2026

(54) CUTTING TOOL ASSEMBLY HAVING A LOW PROFILE TOOL HOLDER

(71) Applicant: Kennametal Inc., Latrobe, PA (US)

(72) Inventors: Satish P. Chinnakar, Bagalkot (IN); Igor Kaufmann, Nuemberg (DE); Anwar Sadat Mohideen Abdul, Burgthann (DE); Mahesh Pattar, Bengaluru (IN)

(21) Appl. No.: 19/454,649

(22) Filed: Jan. 21, 2026

(30) Foreign Application Priority Data
Feb. 27, 2025 (IN) 202541017516

(51) Int. Cl. B23B 27/16

(52) U.S. Cl. CPC B23B 27/1603

(57) ABSTRACT

A cutting tool assembly including a low profile tool holder for securing a cutting insert. The tool holder includes a cylindrical body having a flat front face and rearwardly facing serrated face. The cylindrical body includes a clamping jaw having a clamping block, upper jaw and lower jaw. The upper jaw and lower jaw project radially beyond the cylindrical body. The clamping block and upper jaw are formed integral with the cylindrical body of the low profile tool holder and flex with respect thereto. The clamping block has a beveled circumferential surface and a clamping hole for receiving a fastener. The clamping block and upper jaw flexibly close against a cutting insert positioned between the upper jaw and lower jaw when the fastener is tightened against the beveled surface thereby securing the cutting insert in position.

### CROSS-REFERENCE TO RELATED APPLICATION

This application claims priority to Indian Patent Application No. 202541017516, entitled CUTTING TOOL ASSEMBLY HAVING A LOW PROFILE TOOL HOLDER filed February 27, 2025.

### FIELD OF THE INVENTION

The present invention relates generally to a cutting tool assembly including a low profile tool holder having serrations and a two part clamping jaw for holding a cutting insert.

### BACKGROUND INFORMATION

A large portion of cutting tools for cutting or chip-removing machining, are assembled from a tool holder having two or more parts, which can be released from each other. For instance, cutting inserts and other types of hard machining members of rotatable tools, such as milling cutters and drills, are mounted on miscellaneous basic bodies or coupling parts. In turning tools, a coupling part or adapter is most often included with which an insert-carrying or edge-carrying machining part that is releasably connected, e.g. a blade part having a slotting tool for parting or groove-slotting operations.

It is desirable that the tool holders for cutting tools, which are composed of two or more parts, have repeatable mounting and dismounting of the parts while also retaining good precision between the parts in question, e.g. between a basic body and a cutting insert clamped in a tool holder, such that the spatial position for one or more active chip-removing cutting edges should always be the same, even if one of the parts frequently is dismounted or exchanged. The requirements of such position precision are also high in respect of rigidity and stability between the parts. Thus, the parts should withstand prescribed force loads without the cutting edges being dislodged from their predetermined geometrical positions.

It is also desired that the tool holders have a low profile to allow for reduced and/or unobstructed chip flow during the cutting operation when a cutting insert is mounted in the tool holders.

### SUMMARY OF THE INVENTION

The present invention aims at managing the above-mentioned problems and at improving the flexibility in respect of the possibilities of forming a cutting tool assembly having a low profile tool holder including serrations and a two part clamping jaw having a flexible upper jaw for holding a cutting insert.

In one embodiment, the tool holder includes a cylindrical body having a flat front face and rearwardly facing serrated face. The cylindrical body includes a clamping jaw having a clamping block, upper jaw and lower jaw. The upper jaw and lower jaw project radially beyond the cylindrical body. The clamping block is flexibly joined integral with the cylindrical body of the tool holder by a slot formed from the back of the clamping jaw extending radially to approximate the center of the tool holder and a slot formed above a clamping hole extending to approximate the center of the tool holder. The clamping block has a beveled circumferential surface and the clamping hole for receiving a fastener engaging the tool holder. The clamping block and upper jaw flexibly close against the cutting insert positioned between the upper jaw and lower jaw when the fastener is tightened against the beveled surface thereby securing the cutting insert in position.

These and other aspects of the present invention will be more apparent from the following description.

### BRIEF DESCRIPTION OF THE DRAWINGS

In order that the present invention may be more clearly ascertained, some embodiments will now be described, by way of example, with reference to the accompanying drawings, in which:

FIG. 1 is an exploded perspective view of a cutting tool assembly according to the invention that has been exemplified in the form of a turning tool intended for parting or groove slotting and which includes two parts releasably coupled together with each other in which a cutting insert is applied.

FIG. 2 is an exploded perspective view showing the tool holder of the cutting tool assembly with a serration surface and cutting insert separated from the tool bar.

FIG. 3 is a side view of the tool holder of FIG. 2.

FIG. 4 a top view of the tool holder of FIG. 2.

FIG. 5 is a front view of the tool holder of FIG. 2.

FIG. 6 is a bottom view of the tool holder of FIG. 2; and

FIG. 7 is a rear view of the tool holder of FIG. 2.

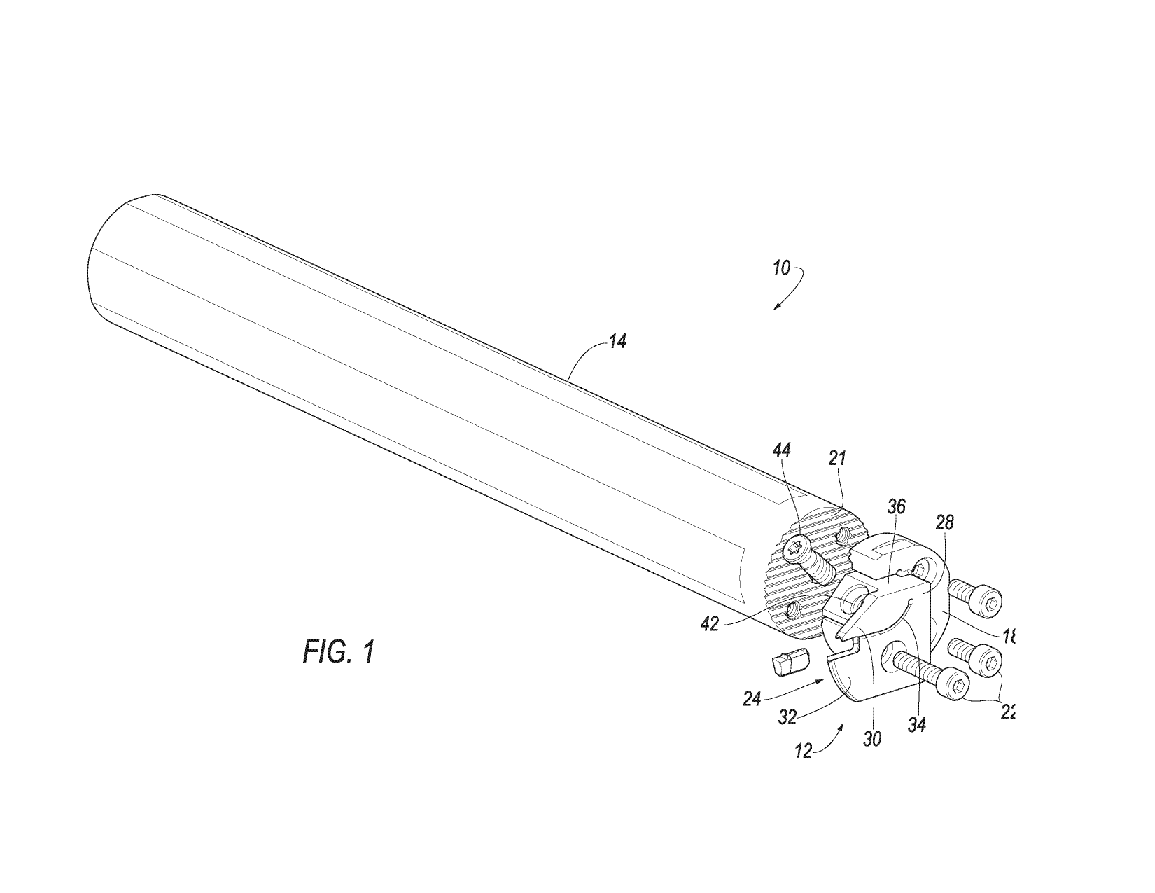

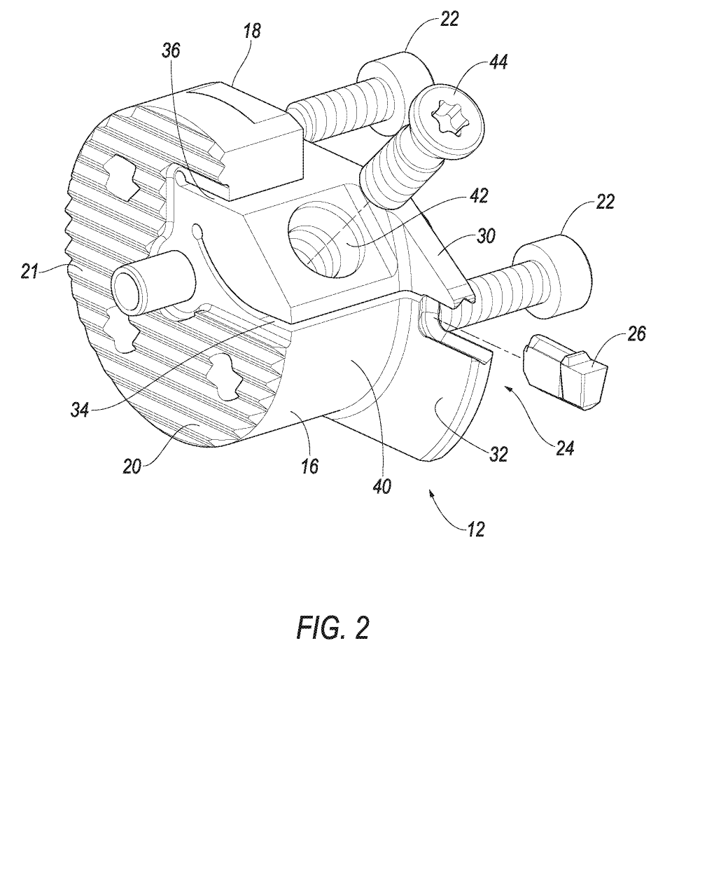

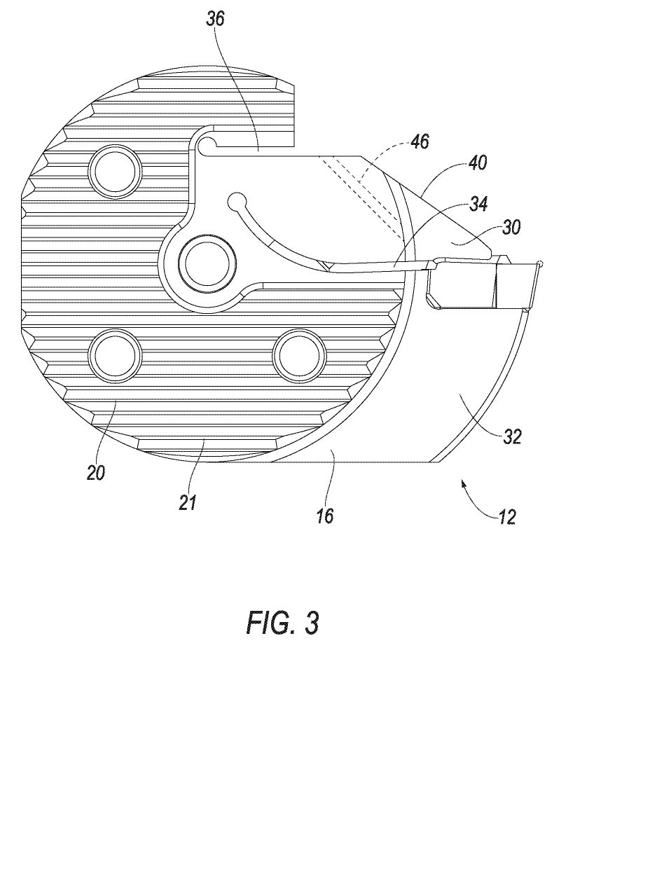

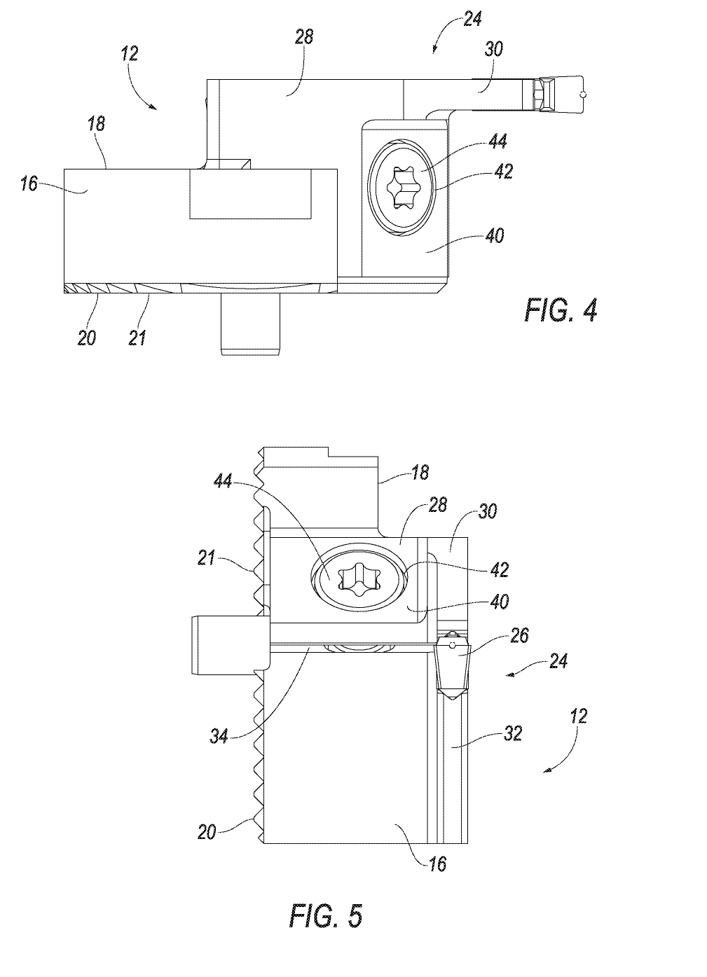

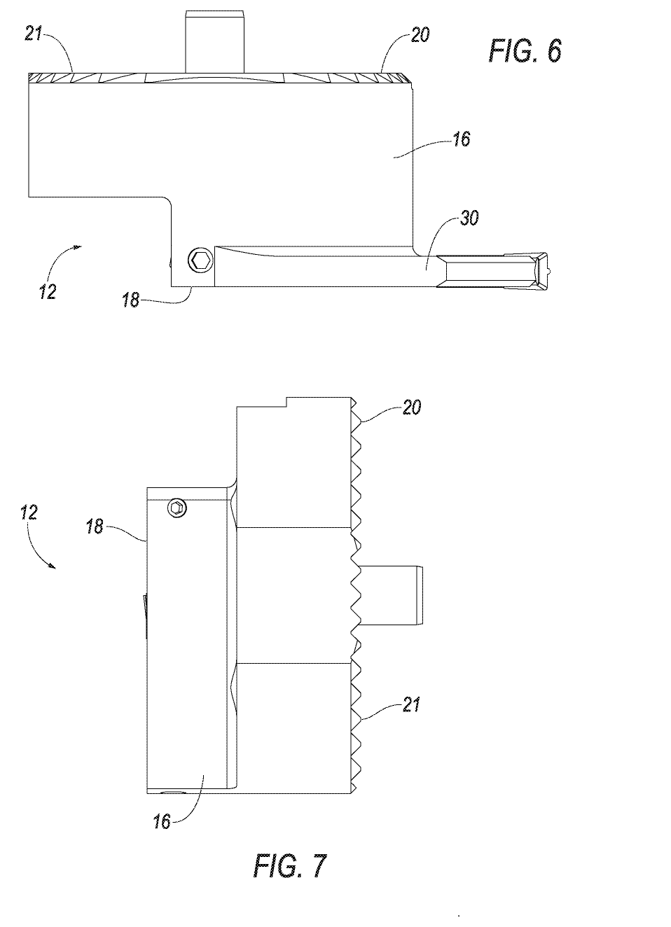

### DETAILED DESCRIPTION

The present disclosure now will be described more fully hereinafter with reference to the accompanying drawings, in which various exemplary implementations are shown. The invention may, however, be embodied in many different forms and should not be construed as limited to the exemplary implementations set forth herein. These example exemplary implementations are just that-examples-and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail-it is impracticable to list every possible variation for every feature described herein. The language of the claims should be referenced in determining the requirements of the invention. As stated above, the present invention is directed

The terminology used herein is for the purpose of describing particular exemplary implementations only and is not intended to be limiting of the invention. As used herein, the singular forms "a", "an" and "the" are intended to include the plural forms as well, unless the context clearly indicates otherwise. As used herein, the term "and/or" includes any and all combinations of one or more of the associated listed items and may be abbreviated as "/".

Terms such as "about" or "approximately" or "on the order of' may reflect amounts, sizes, orientations, or layouts that vary only in a small relative manner, and/or in a way that does not significantly alter the operation, functionality, or structure of certain elements.

It will be understood that when an element is referred to as being "connected" or "coupled" to or "on" another element, it can be directly connected or coupled to or on the other element or intervening elements may be present. In contrast, when an element is referred to as being "directly connected" or "directly coupled" to another element, or as "contacting" or "in contact with" another element, there are no intervening elements present. Other words used to describe the relationship between elements should be interpreted in a like fashion (e.g., "between" versus "directly between," "adjacent" versus "directly adjacent," etc.).

Referring to the drawings, wherein like reference characters represent like elements, there is illustrated a cutting tool assembly 10 including a low profile tool holder 12 connected to a bar like shank member 14. The bar like shank member 14 extends from the low profile tool holder 12 for mounting or attachment to a machine tool as well known in the art. For example, the bar like shank member 14 of the low profile tool holder 12 may be secured to a "pocket" of a turret that forms part of the machine tool. This enables the cutting tool assembly 10 to be moved to various positions in order to perform cutting operations on a rotating workpiece such as bar or tube stock. The depiction of the cutting tool assembly 10 and the low profile tool holder 12 as a grooving cutting tool or cut-off cutting tool is not intended to limit the scope of the invention. The types of cutting devices to which the invention pertains include, but are not limited to, a rotary device, a rotary cut-off device, and an axial grooving rotary device. The actual spirit and scope of the invention are as set forth in the claims hereof.

The low profile tool holder 12 includes a generally cylindrical body 16 having a flat front face 18 and rear face 20. The rear face includes serrations 21. The low profile tool holder 12 is secured by bolts 22 to the forwardly facing end 24 of the bar like shank member 14. The complimentary serrations 21 formed in the forwardly facing end 24 of the bar like shank member 14 mesh with the serrations 21 formed in the rear face 20 of the low profile tool holder 12 to fix the relative position of the low profile tool holder when the bolts 22 are secured.

The front face 18 of the low profile tool holder 12 includes a clamping jaw 24 to removably secure a cutting insert 26. The cutting insert may be of any type well known in the art for the intended cutting operation. Exemplary of typical cutting inserts reference is made to US Patent Nos. 9,579,727; US9,586,265; US9,168,588 and US9,242,300, incorporated herein by reference.

As shown in the figures, the clamping jaw 24 includes a clamping block 28, an upper jaw 30 and a lower jaw 32. The lower jaw 32 is fixed with respect to the low profile tool holder 12. The lower jaw 32 is formed in the front face 18 of the low profile tool holder 12 and projects approximate radially from a central axis of the low profile tool holder beyond the circumferential side surface of the cylindrical body 16 of the low profile tool holder. The lower jaw 32 is configured to receive and hold the bottom of the cutting insert 26.

The upper jaw 30 and clamping block 28 are formed integral with the cylindrical body 16 of the low profile tool holder 12. The upper jaw 30 projects radially from the clamping block 28 beyond the circumferential surface of the cylindrical body 16 of the low profile tool holder 12. The clamping block 28 and, in turn, the upper jaw 30 is flexibly joined to the low profile tool holder 12 by slots 34, 36 formed within the low profile tool holder thereby facilitating the clamping and unclamping of the upper jaw. As shown in the figures, a slot 34 is formed from the rear of the clamping jaw 24 extending radially to approximate the center of the low profile tool holder 12. An additional slot 36 is formed above a clamping hole 42 extending to approximate the center of the low profile tool holder 12. The clamping block 28 rear face is a flat surface and does not include serrations to allow the clamping block to flex independent of the shank member 14 and cylindrical body 16. A pin extends from the rear face 20 and is received within a complimentary hole in the forward end 24 of the shank member 14.

As shown, the slot 36 is formed horizontal or parallel to the upper seating surface of the lower jaw 32. The slot 36 facilitates serrations 21 extending over and above the clamping block 28. The serrations 21 extending over the clamping block 28 provide increased torsional rigidity of the cylindrical body 16 when bolted to the shank member 14 and the fastener 44 is tightened flexing the upper jaw 30.

The circumferential side surface 40 of the clamping block 28 of the low profile tool holder 12 is beveled to provide a low profile tool holder with improved chip flow during the cutting operation. The beveled circumferential side surface 40 of the clamping block 28 includes a clamping hole 42 for receiving a fastener 44 that is threaded into the low profile tool holder 12. The clamping hole 42 is formed in the beveled circumferential side surface 40 of the clamping block 28.

As the fastener 44 is tightened, the clamping block 28 and upper jaw 30 flexibly close against the cutting insert 26 positioned between the upper jaw and stationary lower jaw 32 thereby securing the cutting insert in position. The slots 34, 36 allow the upper jaw 30 to elastically deform against the cutting insert 26 when the fastener 44 is tightened. When the fastener 44 is tightened the slot 34 extending from the rear of the clamping jaw 24 flexes closed and the slot 36 above the clamping hole 42 flexes opens. The synergistic effect of the slots 34, 36 and the fastener 44 allow for simple clamping of the cutting insert 26 within the clamping jaw 24.

The top surface of the lower jaw 32 and bottom surface of the upper jaw 30 have a profile holding structure for forming positive locking with complimentary surfaces on the bottom and top of the cutting insert 26. As shown in the figures, the profiled holding structure is in the form of a groove, in particular a prism groove which can have a V-shaped or trapezoidal form.

The low profile tool holder 12 may include internal coolant channels 46 to provide coolant flow to the cutting interface between the cutting insert 26 and the workpiece as well known in the art.

The patents and patent applications referenced herein are hereby incorporated by reference.

Whereas particular embodiments of this invention have been described above for purposes of illustration, it will be evident to those skilled in the art that numerous variations of the details of the present invention may be made without departing from the invention as defined in the appended claims.

1. A cutting tool assembly comprising:
a low profile tool holder for securing a cutting insert including a cylindrical body having a flat front face and rear face;
the cylindrical body including a clamping jaw having a clamping block, upper jaw and lower jaw; the upper jaw and lower jaw projecting radially beyond the cylindrical body;
the clamping block flexibly joined integral with the cylindrical body of the low profile tool holder by a slot formed from the back of the clamping jaw extending radially to approximate the center of the low profile tool holder and a slot formed above a clamping hole extending to approximate the center of the low profile tool holder;
wherein the rear face includes serrations extending over and above the clamping block;
and wherein the clamping block has a clamping hole for receiving a fastener engaging the low profile tool holder, wherein the clamping block and upper jaw flexibly close against the cutting insert positioned between the upper jaw and lower jaw when the fastener is tightened thereby securing the cutting insert in position.

2. The cutting tool assembly of claim 1 wherein the clamping block has a beveled circumferential surface, the fastener is tightened against the beveled surface thereby securing the cutting insert in position.

3. The cutting tool assembly of claim 1 wherein a rear face of the clamping block is a flat surface.

4. The cutting tool assembly of claim 1 wherein the slot formed above the clamping hole is formed horizontal to the lower jaw.

5. The cutting tool assembly of claim 2 wherein a rear face of the clamping block is a flat surface.

6. The cutting tool assembly of claim 2 wherein the slot formed above the clamping hole is formed horizontal to the lower jaw.

7. The cutting tool assembly of claim 1 further comprising coolant channels.

8. The cutting tool assembly of claim 1 further comprising a shank member for mounting to a machine tool.

9. The cutting tool assembly of claim 8 wherein the shank member includes a forwardly facing end having serrations.

10. The cutting tool assembly of claim 9 wherein the serrations of the shank member mesh with serrations formed in the rear face of the tool holder.
